(19) United States
(12) Patent Application Publication
(10) Pub. No.: US 2014/0352457 A1
(43) Pub. Date: Dec. 4, 2014

(54) ELECTRONIC DEVICE AND METHOD FOR TESTING BUTTON FUNCTION

(71) Applicants: Hong Fu Jin Precision Industry (ShenZhen) Co., Ltd., Shenzhen (CN); Hon Hai Precision Industry Co., Ltd., New Taipei (TW)

(72) Inventors: YA-GUO WANG, Shenzhen (CN); CHUN-CHING CHEN, New Taipei (TW)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/260,556

(22) Filed: Apr. 24, 2014

(30) Foreign Application Priority Data
May 31, 2013 (CN) 201310211364X

(51) Int. Cl. G01M 99/00

(52) U.S. Cl. CPC G01M 99/008
USPC 73/865.3

(57) ABSTRACT

An electronic device includes a storage unit, a pressing apparatus, a processing unit, and a button unit having a number of buttons. Identification (ID) information of each of the buttons and a predetermined signal corresponding to each of the buttons are stored in the storage unit. When a control signal is generated by the button unit after a button is pressed, the ID information of the button that is pressed is obtained from the storage unit. The control signal is compared with the corresponding predetermined signal to determine whether the pressed button is malfunctional.

### FIELD

Embodiments of the present disclosure generally relate to test technologies of electronic devices, and particularly to a method for testing button functions of an electronic device.

### BACKGROUND

Many electronic devices, such as DVD players and set top boxes, include a plurality of buttons to control the electronic devices to perform corresponding functions. During the manufacturing process of the electronic devices, it is very important to test functions of the buttons. In a typical test method, the functions of buttons are manually tested by pressing each button, and then a tester can manually determine whether the electronic device performs corresponding functions.

### BRIEF DESCRIPTION OF THE DRAWINGS

FIG. 1 shows a schematic block diagram of an embodiment of an electronic device including a button unit.

FIG. 2 is a flowchart of one embodiment of a method for testing button functions of the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.” The reference “a plurality of” means “at least two.”

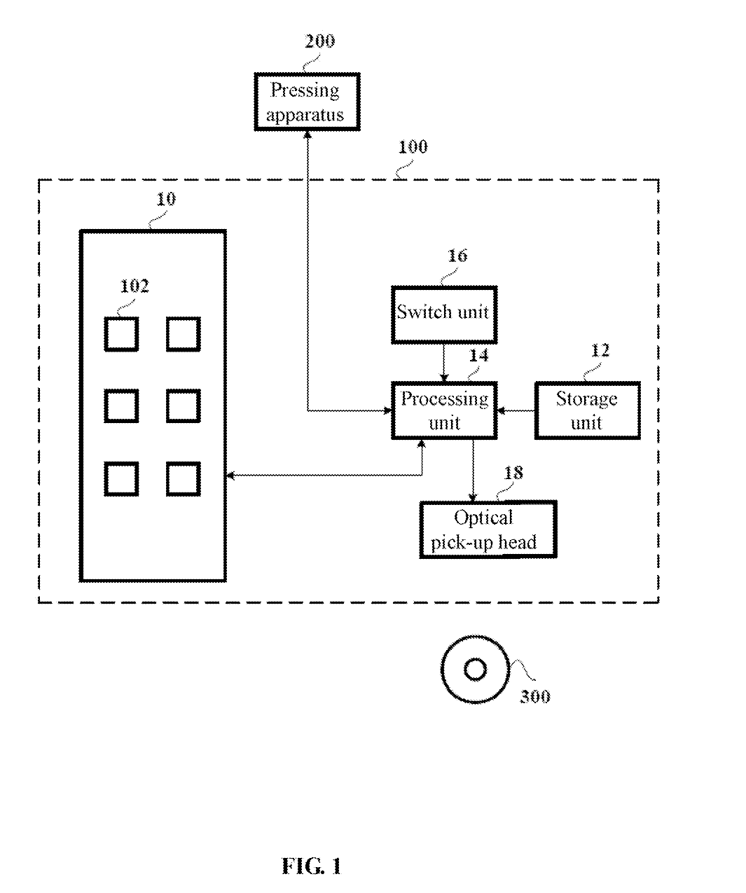

FIG. 1 illustrates a schematic block diagram of an electronic device 100. The electronic device 100 can include a button unit 10, a storage unit 12, and a processor 14. In this embodiment, the electronic device 100 is a DVD player.

The button unit 10 can include a plurality of buttons 102. The buttons 102 can include a volume up button, a volume down button, a pause/play button, a power button, a backspace button, and other kinds of buttons. In this embodiment, a corresponding control signal is generated when one of the buttons 10 is pressed. Each button 10 corresponds to a control signal. The control signal can be a digital signal, such as “0000,” “0001,” and “0011,” or a logical voltage signal, such as 0V, 3.3V, 2.5V, and 5V.

The storage unit 12 stores identification (ID) information of each of the buttons 102 and a predetermined signal corresponding to each of the buttons 102. The

ID information of each button 102 can be a button name of each button 102.

The processing unit 14 is electrically connected to a pressing apparatus 200 located outside of the electronic device 100. In at least one embodiment, the pressing apparatus 200 is coupled with the button unit 10. The pressing apparatus 200 is configured to be positioned on the button unit 10 to press each of the buttons 102. The processing unit 14 is configured to control the pressing apparatus 200 to press the buttons 102 of the button unit 10 in turn at intervals. In one example, the pressing apparatus 200 can be a manipulator located at a production line of the electronic device 100.

In at least one embodiment, the processing unit 14 is further electrically connected to the button unit 10, and detects whether a control signal is generated by the button unit 10 within a predetermined time duration (for example, three seconds) after a button 102 is pressed. When the control signal is generated, the processing unit 14 determines the ID information of the corresponding button 102 pressed by the pressing apparatus 200. In this embodiment, the predetermined time duration is less than a time interval in which two of the buttons 102 are successively pressed.

In at least one embodiment, the processing unit 14 further obtains the predetermined signal corresponding to the pressed button 102 from the storage unit 12 according to the ID information of the pressed button 102, and compares the control signal with the obtained predetermined signal to determine whether the pressed button 102 is malfunctional. In this embodiment, when the control signal is the same as the obtained predetermined signal, the pressed button 102 is determined to be normal. Otherwise, the pressed button 102 is determined to be malfunctional.

In at least one embodiment, when the processing unit 14 does not detect the control signal generated by the button unit 10 within the predetermined time duration after the button 102 is pressed, the pressed button is determined to be malfunctional. The processing unit 14 can be a moving picture expert group (MPEG) chip.

In at least one embodiment, the electronic device 100 further includes a switch unit 16 and an optical pick-up head 18. The switch unit 16 is configured to switch the processing unit 14 between a test mode and a data reading mode. The switch unit 16 can be a mechanical key. For example, when the switch unit 16 is operated for a first time, the processing unit 14 is switched to the test mode. In the test mode, the processing unit 14 controls the pressing apparatus 200 to press the buttons 102 of the button unit 10 to test the functions of the buttons 102. When the switch unit 16 is operated for a second time, the processing unit 14 is switched to the data reading mode. In the data reading mode, the processing unit 14 controls the optical pick-up head 18 to read data from an optical disk 300, and then encodes the data read from the optical disk 300. The optical disk 300 can be received in the electronic device 100.

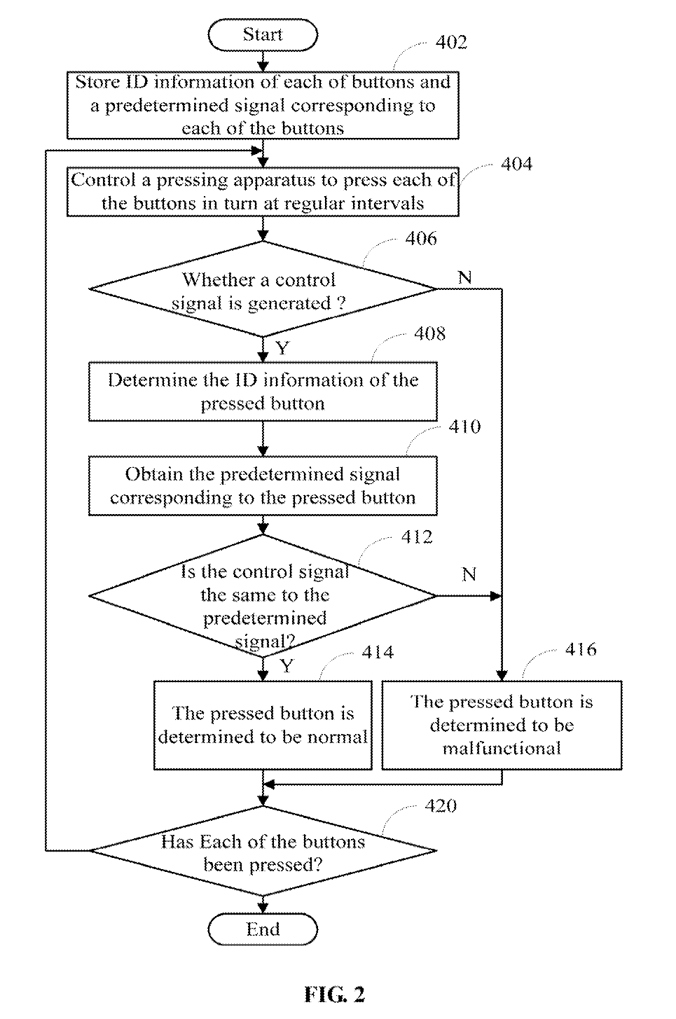

FIG. 2 is a flowchart of one embodiment of a method for testing button functions of the electronic device 100 of FIG. 1. Depending on the embodiment, additional steps may be added, others removed, and the ordering of the steps may be changed.

In 402, the storage unit 10 stores identification (ID) information of each of the buttons 102 and a predetermined signal corresponding to each of the buttons 102.

In 404, the processing unit 14 controls the pressing apparatus 200 to press the buttons 102 of the button unit 10 in turn at intervals.

In 406, the processing unit 14 detects whether a control signal is generated by the button unit 10 within a predetermined time duration (e.g., three seconds) after a button 102 is pressed. If the corresponding control signal is generated by the button unit 10 within the predetermined time duration after the button 202 is pressed, 408 is implemented. Otherwise, 416 is implemented.

In 408, the processing unit 14 determines the ID information of the corresponding button 102 pressed by the pressing apparatus 200.

In 410, the processing unit 14 obtains the predetermined signal corresponding to the pressed button 102 from the storage unit 12 according to the ID information of the pressed button 102.

In 412, the processing unit 14 determines whether the control signal is the same as the obtained predetermined signal. If the control signal is the same as the obtained predetermined signal, 414 is implemented. Otherwise, 416 is implemented.

In 414, the processing unit 14 determines that the pressed button 102 is normal, the procedure goes to 420.

In 416, the processing unit 14 determines that the pressed button 102 is malfunctional.

In 420, the processing unit 14 determines whether each of the buttons 102 has been pressed. If each of the buttons 102 has been pressed, the procedure ends. Otherwise, the procedure returns to 406.

Although certain embodiments of the present disclosure have been specifically described, the present disclosure is not to be construed as being limited thereto. Various changes or modifications may be made to the present disclosure without departing from the scope thereof. The embodiments described herein are illustrative only, and are not intended to limit the scope of the following claims.

What is claimed is:

1. An electronic device, comprising:
a button unit comprising a plurality buttons;
a storage unit storing identification (ID) information of each of the plurality of buttons and a predetermined signal corresponding to each of the plurality of buttons; and
a processing unit electrically connected to a pressing apparatus external to the electronic device, wherein the processing unit is configured to:
control the pressing apparatus to press the plurality of buttons of the button unit in turn at intervals;
detect whether a control signal is generated by the button unit within a predetermined time duration after a button is pressed;
determine the ID information of the corresponding button pressed by the pressing apparatus when the control signal is generated;
obtain the predetermined signal corresponding to the pressed button from the storage unit according to the ID information of the pressed button; and
compare the control signal with the obtained predetermined signal to determine whether the pressed button is malfunctional.

2. The electronic device according to claim 1, wherein the processing unit comprises a test mode and a data reading mode, the electronic device further comprises a switch unit and a optical pick-up head, the switch unit is configured to switch the processing unit between the test mode and the data reading mode.

3. The electronic device according to claim 2, wherein when the processing unit is switched to the test mode, the processing unit controls the pressing apparatus to press the plurality of buttons of the button unit in turn at intervals.

4. The electronic device according to claim 2, wherein when the processing unit is switched to the data reading mode, the processing unit controls the optical pick-up head to read data from an optical disk received in the electronic device, and then encodes the data read from the optical disk.

5. The electronic device according to claim 1, wherein when the control signal is the same as the obtained predetermined signal, the pressed button is determined to be normal; when the control signal is different from the obtained predetermined signal, the pressed button is determined to be malfunctional.

6. The electronic device according to claim 1, wherein when the processing unit does not detects the control signal that is generated by the button unit within the predetermined time duration after the button is pressed, the pressed button is determined to be malfunctional.

7. The electronic device according to claim 1, wherein the electronic device is a DVD player.

8. A method for testing button functions of a button unit having a plurality of buttons of an electronic device, the method comprising:
storing identification (ID) information of each of the plurality of buttons and a predetermined signal corresponding to each of the plurality of buttons using a storage unit of the electronic device;
controlling a pressing apparatus external to the electronic device to press the plurality of buttons in turn at intervals using a processing unit of the electronic device; and
detecting whether a control signal is generated by the button unit within a predetermined time duration after a button is pressed;
determining the ID information of the corresponding button pressed by the pressing apparatus when the control signal is generated;
obtaining the predetermined signal corresponding to the pressed button from the storage unit according to the ID information of the pressed button; and
comparing the control signal with the obtained predetermined signal to determine whether the pressed button is malfunctional.

9. The method according to claim 8, wherein the processing unit comprises a test mode and a data reading mode, the electronic device further comprises a switch unit and a optical pick-up head, the switch unit is configured to switch the processing unit between the test mode and the data reading mode; when the processing unit is switched to the test mode, the controlling step is implemented by the processing unit.

10. The method according to claim 9, wherein when the processing unit is switched to the data reading mode, the processing unit controls the optical pick-up head to read data from an optical disk received in the electronic device, and then encodes the data read from the optical disk.

11. The method according to claim 8, wherein when the control signal is the same as the obtained predetermined signal, the pressed button is determined to be normal; when the control signal is different from the obtained predetermined signal, the pressed button is determined to be malfunctional.

12. The method according to claim 8, wherein when the processing unit does not detects the control signal that is generated by the button unit within the predetermined time duration after the button is pressed, the pressed button is determined to be malfunctional.

13. The method according to claim 8, wherein the electronic device is a DVD player.
